(19) United States
(12) Patent Application Publication
(10) Pub. No.: US 2024/0346238 A1
(43) Pub. Date: Oct. 17, 2024

(54) SYSTEM AND METHOD FOR GENERATING A BRIEF OF CONVERSATION SUMMARIES USING A LARGE LANGUAGE MODEL

(71) Applicant: GONG.io Ltd., Ramat Gan (IL)

(72) Inventors: Eyal BEN-DAVID, Kibbutz Yagur (IL); Inbal HOREV, Tel Aviv (IL); Raz NUSSBAUM, Tel Aviv (IL); Adi KOPILOV, Tel Aviv (IL); Nadav Shai Oved SHALEV, Tel Mond (IL); Shlomi MEDALION, Lod (IL)

(73) Assignee: GONG.io Ltd., Ramat Gan (IL)

(21) Appl. No.: 18/638,075

(22) Filed: Apr. 17, 2024

Related U.S. Application Data
(60) Provisional application No. 63/496,592, filed on Apr. 17, 2023.

(51) Int. Cl. G06F 40/166; G06F 16/34

(52) U.S. Cl. CPC G06F 40/166; G06F 16/345

(57) ABSTRACT

Techniques for efficiently generating a brief of a call summary is provided. The method includes ingesting at least one simplified transcript, wherein a simplified transcript is a summarization of a transcript of a call and includes a plurality of bullet points of at least one main subject; representing each bullet point of the plurality of bullet points of the simplified transcript as an embedded vector using an embedding technique; determining at least one grouping of the plurality of bullet points based on the embedded vector, wherein the grouping includes at least one bullet point; feeding the at least one grouping into a trained rephrasing model to generate a rephrased content for each of the at least one grouping; and generating a summarized brief based on the rephrased content of the at least one grouping, wherein the summarized brief is generated as natural language textual data below a predetermined length.

### CROSS-REFERENCE TO RELATED APPLICATIONS

This application claims the benefit of U.S. Provisional Application No. 63/496,592 filed on Apr. 17, 2023, the contents of which are hereby incorporated by reference.

### TECHNICAL FIELD

The present disclosure generally relates to providing a summarization of deals and calls and, more specifically, to improving the accuracy of call summarization by customizing large data models.

### BACKGROUND

Customer service representatives, account executives, sales development representatives, customer success managers, and other business-to-customer (B2C) and business-to-business (B2B) representatives rely on engaging with customers or potential customers to achieve their business goals, such as meeting sales quotas, obtaining customer satisfaction, and so on. An important part of achieving such goals is following up with customers and providing them with all the information that they need to agree to close a deal.

Engagement with customers occurs via different communication channels, including phone calls, video calls, text messages, electronic mail (emails), and so on. In addition, the stage (or status) of a deal and the history of customer engagement with regard to that deal are typically recorded in a customer relationship management (CRM) system. These days, a sales process is very complex in that it requires the involvement of multiple sales professionals at various hierarchical levels, such as, for example, sales development representatives (SDRs), sales representatives, front-line managers (FLMs), and account executives. Each group of sales professionals may have different duties and responsibilities. To meet their respective goals, sales professionals need to share accurate information with each other. For example, SDRs document cold calls and pass prospect information to FLMs, and FLMs monitor deal progress and identify coaching opportunities to enhance the performance of account executives in diverse situations. Account executives prepare for future calls, draft follow-up emails, and summarize previous calls.

Sales professionals face the challenge of processing extensive deal data to generate and record accurate information related to a stage of a deal and/or engagement with the customer. These tasks are currently performed manually by sales professionals. However, in view of the exponential amount of information and communications (emails, calls, messages, CRM data, etc.) being processed, these tasks are time-consuming and prone to human error, which can result in critical details being overlooked and a subsequent decline in sales productivity.

Summarization tools are limited to providing metadata about an engagement on a single communication channel. For example, such insights may include information regarding the participants on a call, data on the call, and the subject of the call. However, an automated summary of the sales process and the engagement with the prospects are not generated, neither on individual channels nor across channels. For example, an SDR and a potential customer may exchange emails and text messages before meeting over a sales call. Such emails and text messages are currently not factored into the sales call summary generated by existing tools.

Summarization tools face the challenge of dealing with ambiguity and subjectivity in generating subject categories for meetings or calls. Conversations can cover a wide range of topics, and the boundaries between categories may be fuzzy or open to interpretation. Different participants may perceive and categorize the same discussion differently based on their perspectives and priorities, leading to inconsistencies in the generated categories. Resolving this issue requires robust algorithms and methodologies capable of capturing the diverse nuances and contexts of conversational topics accurately.

Meeting transcript tools face challenges in ensuring the accuracy and reliability of the transcriptions. Automatic Speech Recognition technology, which is often used in these tools, may struggle with accents, background noise, multiple speakers, and technical jargon, leading to inaccuracies in the transcribed text. These errors can impact the usability and trustworthiness of transcripts, especially in business settings where precision is crucial.

Solutions for improving the efficiency and accuracy of automated summarization of sales engagements (e.g., calls) are therefore highly desirable. In particular, solutions that allow for reducing the amount of computing resources (memory and processors) needed to be devoted to processing high volumes of data are desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for efficiently generating a transcript summary. The method comprises: ingesting at least one simplified transcript, wherein a simplified transcript is a summarization of a transcript of a call and includes a plurality of bullet points of at least one main subject; representing each bullet point of the plurality of bullet points of the simplified transcript as an embedded vector using an embedding technique; determining at least one grouping of the plurality of bullet points based on the embedded vector, wherein the at least one grouping includes at least one bullet point; feeding the at least one grouping into a trained rephrasing model to generate a rephrased content for each of the at least one grouping; and generating a summarized brief based on the rephrased content of the at least one grouping, wherein the summarized brief is generated as natural language textual data below a predetermined length.

Certain embodiments disclosed herein also include a non-transitory computer readable medium having stored thereon causing a processing circuitry to execute a process, the process comprising: ingesting at least one simplified transcript, wherein a simplified transcript is a summarization of a transcript of a call and includes a plurality of bullet points of at least one main subject; representing each bullet point of the plurality of bullet points of the simplified transcript as an embedded vector using an embedding technique; determining at least one grouping of the plurality of bullet points based on the embedded vector, wherein the at least one grouping includes at least one bullet point; feeding the at least one grouping into a trained rephrasing model to generate a rephrased content for each of the at least one grouping; and generating a summarized brief based on the rephrased content of the at least one grouping, wherein the summarized brief is generated as natural language textual data below a predetermined length.

Certain embodiments disclosed herein also include a system for efficiently generating a transcript summary. The system comprises: a processing circuitry; and a memory, the memory containing instructions that, when executed by the processing circuitry, configure the system to: ingest at least one simplified transcript, wherein a simplified transcript is a summarization of a transcript of a call and includes a plurality of bullet points of at least one main subject; represent each bullet point of the plurality of bullet points of the simplified transcript as an embedded vector using an embedding technique; determine at least one grouping of the plurality of bullet points based on the embedded vector, wherein the at least one grouping includes at least one bullet point; feed the at least one grouping into a trained rephrasing model to generate a rephrased content for each of the at least one grouping; and generate a summarized brief based on the rephrased content of the at least one grouping, wherein the summarized brief is generated as natural language textual data below a predetermined length.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for generating simplified transcripts according to an embodiment.

FIG. 3 shows an example prompt generated according to an embodiment.

FIG. 4 is a flowchart illustrating a method for generating conversation highlights summaries (or call briefs) according to an embodiment.

FIG. 5 is a flowchart illustrating a method for generating communication summaries (or communication briefs) according to an embodiment.

FIG. 6 is a flowchart illustrating a method for generating deal summaries according to an embodiment.

FIG. 7 is a flowchart illustrating a method for generating conversation categories.

FIG. 8 is a schematic diagram of a summary generator according to an embodiment.

### DETAILED DESCRIPTION

The various disclosed embodiments include methods and systems for efficiently processing message data in order to generate calls-to-action using progressive filtering. The disclosed embodiments filter message data to remove redundant messages, irrelevant messages, or messages that otherwise do not require follow-up actions. Moreover, the progressive filtering used herein allows for filtering in stages, with one filtering stage being used to improve the next filtering stage. In particular, the filtering may be performed using less resource-intensive computing processes in earlier stages, and more accurate but more resource-intensive computing processes in later stages to conserve resources by applying more resource-intensive filtering to only a limited subset of the message data.

In at least some embodiments, a system and method for automatically generating sales call summaries and/or deal summaries using a specific-trained language model (hereinafter “STLM”) are provided. In an embodiment, relevant information from conversations stored or derived from multiple sources is extracted and processed to provide an accurate prompt to the STLM. The STLM's output includes a comprehensive sales call summary related to a deal. The sources of information may include, but are not limited to, call sentiments, call topics, follow-up actions, and so on. Such information is derived from transcripts' calls, messages, CRM data, and more.

The generated summaries' accuracy is based on the accuracy of the prompt (fed to the model) and the specific-trained language model. According to the disclosed embodiments, the STLM is trained on sales data related to a specific customer. Thus, general language models, such as Generative Pre-trained Transformer-3 (GPT-3), may not be applicable or provide the required accuracy for the model. To further improve the accuracy of the generated summaries, techniques are disclosed to provide an accurate and concise prompt to the STLM. The concise prompt is generated from a formatting process that generates a unified data format of the input data which includes transcript data, customer data, topic data, and sentiment data. The prompt will typically include an overview of the meeting including background details, information on the meeting participants, conversation highlights, and the like.

For the reasons noted above, the disclosed embodiments may be utilized to efficiently arrive at an accurate summary of sales conversations and deals, thereby conserving computing resources for generating such summaries and improving the productivity of sales professionals.

Furthermore, human operators subjectively evaluate the importance and classification of speech content during the meeting based on their own personal past experiences, educational experiences, and professional experiences, which often lead to inaccurate highlight summaries of the meeting.

Additionally, when utilizing a human operator for generating meeting transcriptions and meeting summaries, the challenge of ensuring the privacy and security of sensitive information discussed during meetings arises.

Moreover, machine learning algorithms are being implemented to design language models that are capable of contextual understanding of textual data. However, due to the complexity of language and communications, training of such language models often requires an extensively large amount of data, resources, and memory which takes much time to process.

Furthermore, it may be desired to generate language models for particular areas, industries, or cultures in order to effectively analyze the textual data in consideration of distinct terminologies and meanings. However, generating such tagged language models faces challenges in the limited amount of data, resources, and time.

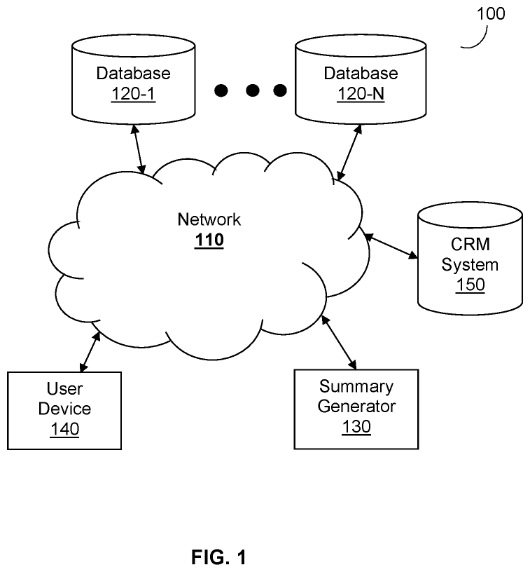

FIG. 1 shows an example network diagram 100 utilized to describe the various disclosed embodiments. In the example network diagram 100, a plurality of databases 120-1 through 120-N (hereinafter referred to individually as a database 120 and collectively as databases 120, merely for purposes of simplicity), a summary generator 130, a user device 140, and a CRM system 150 communicating via a network 110. The network 110 may include but is not limited to, a wireless, a cellular, or wired network, a local area network (LAN), a wide area network (WAN), a metro area network (MAN), the Internet, the worldwide web (WWW), similar networks, and any combination thereof.

A database 120 stores message data that may be related to conversations, for example, but not limited to, textual conversations, between customers and company representatives, such company representatives including, but not limited to, sales professionals. Such message data may include but is not limited to, email messages, chat logs, instant messages, or other text, or data otherwise, including contents of communications or content related to communications between and among individuals. The messages may be realized as types of communications such as, but not limited to, emails, short message service (SMS) messages, text messages, instant messages, social media posts, call statistics (e.g., who spoke on a call, how much that person spoke, and when during the call that person spoke), portions thereof, and the like. Such message data may therefore include messages for which it is desirable to follow up or summarize, for example, in order to close a sale or to provide assistance to close a sale. As noted above, a significant amount of such message data may be generated on any given day, particularly for large call centers with hundreds or thousands of employees.

A database 120 also includes transcript data related to audio/video conversations, for example, but not limited to, audio/video conversations between customers and company representatives or sales professionals. Such transcript data may include, but is not limited to, transcripts obtained from web conference calls, phone calls, and the like. A database 120 also includes topic data related to topics identified through each call. A topic is the context of the subject matter in the text. Examples of topics include the subject matter of, for example, but not limited to, “small talk,” “pricing,” “next step,” “contract,” “sports,” and so on. A database 120 also includes sentiment data identifying a sentiment through each call. Sentiment may be positive, negative, or neutral. In an embodiment, textual data includes transcript data and/or message data.

The summary generator 130 is configured to process the data in the database 120 and customer data obtained from the CRM system 150 to generate a sales call summary using the processed message data in accordance with the various disclosed embodiments. A generated sales call summary may include call highlights, deal highlights, call briefs, deal briefs or summaries, follow-up emails, simplified call transcripts, prospect-side highlights, assistance with deal prediction, and assistance with automatically completing CRM data into a customer relationship management (CRM) system 150. In an embodiment, a summary is generated by an STLM and is a comprehensive summarization that describes the textual data of data chunks. A highlight is a cluster of at least a portion of the transcript data (related to calls, deals, prospect-side data, etc.), which are semantically similar within the cluster. The highlight (e.g., the transcript data, etc.) may be aggregated and/or rephrased and output as a concise write-up in a natural language. Such concise write-up of the highlight may be included in the generated call summary (also sales call summary).

In an embodiment, the summary generator 130 is also configured to retrieve information from the databases 120, including at least call transcript data, messages data, topics data, sentiment data, and customer data. Such information is about a specific customer and a call. The summary generator 130 is further configured to process data at the conversation level. In addition, the summary generator 130 may process correspondence data (e.g., emails, text messages, instant messages (IMs), etc.) and data at a deal level (typically obtained from a CRM system). In an embodiment, the input data includes topic, data, customer data, and sentiment data. In an embodiment, processing the input data includes generating a simplified transcript by converting each segment of transcript data into a series of third-person bullet points. To provide a sales call summary, the summary generator 130 is further configured to cluster bullet points into clusters related to undefined conversation topics and generate a summary for each cluster. For predefined call highlights, highlight classifiers are applied to extract relevant bullet points. Then, each bullet point is rephrased according to its associated highlight and category to generate a meaningful summary for each predefined highlight and conversation-adapted category. In an embodiment, the summary generator 130 is configured to generate an overall call brief (e.g., up to five sentences) based on the simplified bullet points. The operation of the generator 130 is further discussed and demonstrated below.

The user device (UD) 140 may be, but is not limited to, a personal computer, a laptop, a tablet computer, a smartphone, a wearable computing device, or any other device capable of receiving and displaying the generated sales call summaries.

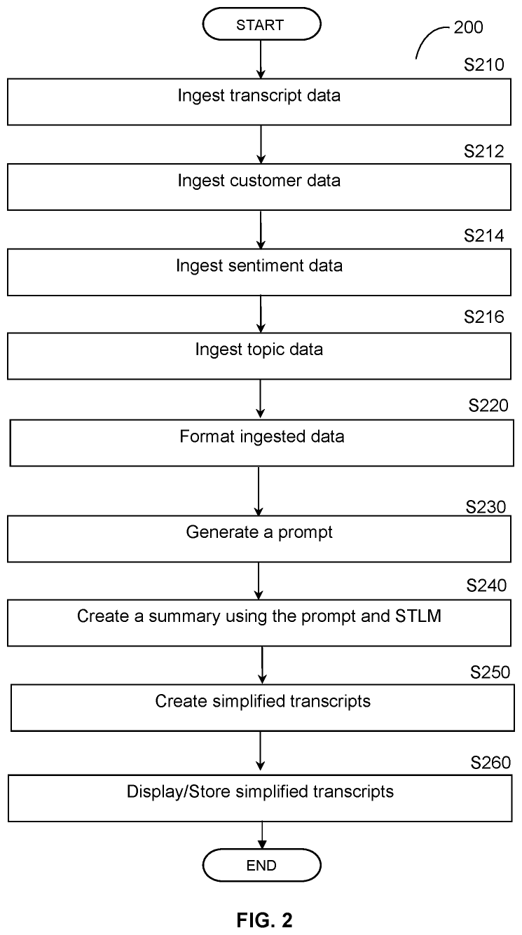

FIG. 2 is an example flowchart 200 illustrating a method for generating simplified transcripts according to an embodiment. In an embodiment, the method is performed by the summary generator 130, FIG. 1. In this embodiment, the simplified transcripts are generated based on calls between sales professionals and prospects (such prospects including customers and potential customers).

At S210, transcript data is ingested. The transcript data may be ingested, for example, from one or more data sources (e.g., one or more of the databases 120, FIG. 1) storing data related to calls. The transcript data includes transcripts of calls conducted by sales professionals at various hierarchical levels throughout the various stages of a deal or a number of deals. The call transcripts are typically generated as a call ends. In some configurations, the transcript data includes transcripts generated in real-time or near real-time during the call. Call transcripts may further include metadata related to each call. Such metadata may include participants in the calls, the data, subject, duration, etc. A call may include a phone call, a video conference, and the like.

At S212, customer data is ingested. The customer data may be ingested, for example, from a CRM system (such as CRM system 150) storing data related to deals offered to customers or potential customers, a stage of such deals, and the information on the customers or potential customers.

At S214, sentiment data is ingested. Such sentiment data may be ingested, for example, from a sentiment database holding sentiments of calls between customers or potential customers. The sentiment is inferred directly from the recording of the call. The sentiment may be positive, negative, or neutral.

At S216, the topic data is ingested. The topic data may be ingested, for example, from a topic database holding topics derived for a call based on its transcripts. A topic is the context of the subject matter in the text (i.e., call transcripts). Examples of topics include the subject matter of, for example, but not limited to, “small talk,” “pricing,” “next step,” “contract,” “sports,” and so on. For each call, there may be one or more different topics.

In an embodiment, S210, S212, S214, and S216 can be performed in parallel or in a different order. In a further embodiment, the customer data and sentiment data are optional.

At S220, one or more formatting processes are applied to the ingested transcript data, and input data (which includes, customer data, topic data, and sentiment data) to create unified data formats. Such formats improve the efficiency of the processing of data by the STLM.

In an embodiment, S220 includes generating data chunks. In an embodiment, the data chunks are generated by splitting the transcript data into a fixed-size of data chunks, splitting the sentiment data into a fixed-size of data chunks, and extracting customer data from the CRM system into a predefined format.

In an embodiment, S220 may include filtering out data chunks that cannot add meaningful information to the generation of the simplified transcripts. The filtering may be based on the topic's data. For example, transcript data chunks associated with a topic of “small talk” may be excluded. Reducing the number of meaningless transcript data chunks would improve the efficiency of the STLM.

At S230, for each transcript data chunk, a prompt for the STLM is created based on the formatted input data. A prompt typically includes a command, background details, and a text on which the command operates. For example, a prompt command may include “Rephrase”, “Format”, “Reword”, and the like. A prompt may include more than one command. The background details may be based on (formatted) data related to customer data and sentiment data. For example, the background details will include information on the meeting participants, such as their names and company titles. In another example, the background details may include company information such as information on their products and relevant industry.

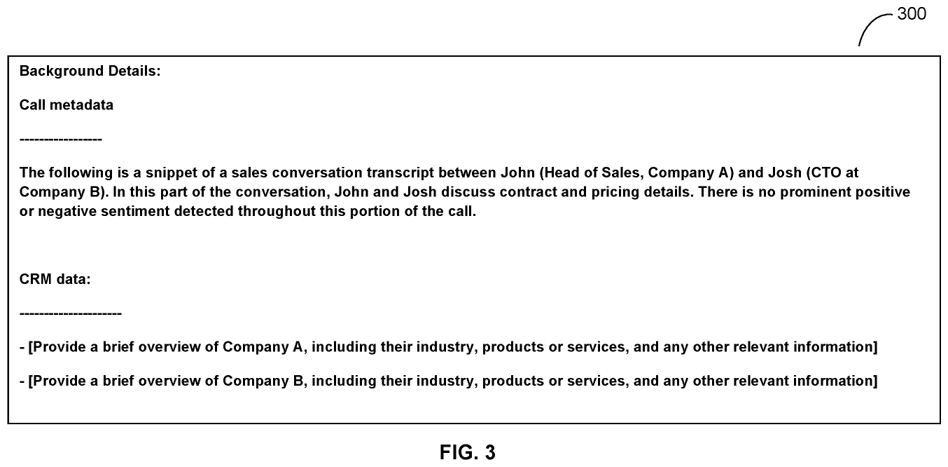

The text that the command operates on includes a transcript data chunk. As such, a prompt may be generated for each transcript data chunk. An example prompt 300 that may be created according to an embodiment is shown in FIG. 3. The background details of the prompt may include, but are not limited to, metadata on the conversation, information on the meeting participants, such as their name, title, and company.

At S240, each created prompt is fed to the STLM, which outputs a summary of the respective transcript data chunk. That is, as a prompt is generated for each transcript data chunk, the STLM outputs a summary per chunk. In an example embodiment, the outputted summary may be in a format of bullet points in a third-person language. However, it should be noted that the summaries can be generated in other formats or forms.

At S250, a simplified transcript is generated by canonizing the summaries output by the STLM. A brief is a canonical representation of the summary and includes a simplified transcript and/or a communication brief.

At S260, the simplified transcript is displayed to the user (e.g., a sales professional), for example, over the user device 140 and stored in a database (e.g., one of the databases 120). In an embodiment, the generated simplified transcript may be utilized to train the STLM.

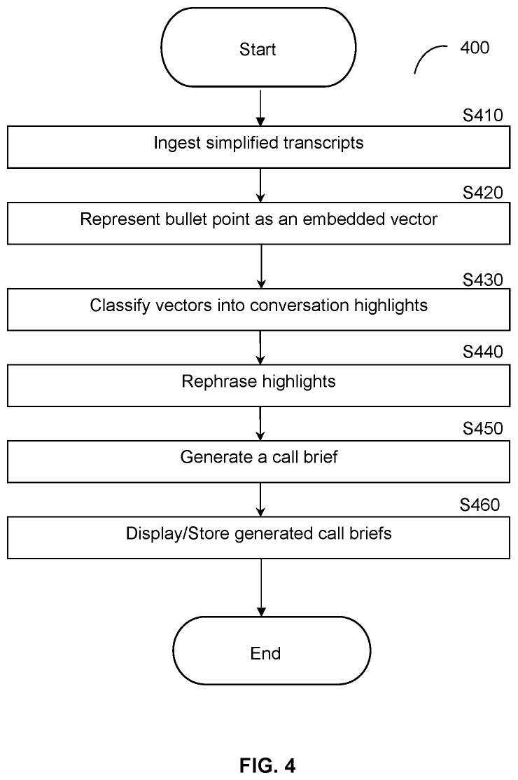

FIG. 4 shows an example flowchart 400 illustrating a method for generating conversation highlight summaries (or call briefs) according to an embodiment. In an embodiment, the method is performed by the summary generator 130, FIG. 1.

At S410, a simplified transcript is ingested. The process for generating the simplified transcript is discussed in greater detail above. In an embodiment, a simplified transcript includes a list of bullet points.

At S420, each bullet point is represented as an embedded vector using an embedding technique. The embedding technique may include a sentence or word embedding technique discussed in the related art. For example, a sentence embedding technique is a representation of document vocabulary that captures the context of a word in a document, semantic and syntactic similarity, relation with other words, and so on. By using a sentence word embedding technique, words are represented as real-valued vectors in a predefined vector space. Each word is mapped to one vector, and the vector values are learned in a way that resembles, for example, a neural network. Sentence or word embedding techniques that may be utilized may include, but not limited to, embeddings from language models (ELMo), bidirectional encoder representations from transformers (BERT), sentence-BERT (SBERT), Instructor, and the like.

At S430, a list of bullet points is classified into conversation highlights. Bullet points may be grouped together. For example, bullet points may be clustered and/or classified. In an embodiment, S430 is performed by applying a classifier which may be, but is not limited to, a machine learning model trained to classify snippets of text (in their embedded form) into such highlights. Such a classifier is trained to determine the types or classifications (hereinafter “highlights”) of the bullet points. Examples of such bullet points may include action items, a customer pain point, a customer request, and a customer question. In an embodiment, the bullet points are classified into groups and identified as a predefined conversation highlight of a plurality of predefined conversation highlights.

For example, the bullet point, “John will send a follow-up email”, would be classified as an action item. The classifier may also be trained to identify bullet points lacking relevance in a particular context, such as “the weather sure is nice today” during a sales call. It should be noted that a bullet point can be classified into one or more highlights. An example implementation of a classifier trained to classify text snippets into highlights is discussed in U.S. patent application Ser. No. 17/830,255, titled, “Method for Summarization and Ranking of Text of Diarized Conversations”, assigned to the common assignee and is hereby incorporated by reference.

At S440, the highlights are fed into a rephrasing language model trained to rephrase the highlights into a concise, fluent, and self-contained sentence(s), which includes the important information from the bullet points regarding each of the identified highlights. In an embodiment, the prompt to the rephrasing language model may include the simplified transcripts and each identified highlight. The rephrasing language model may be trained on rephrasing algorithms including, for example, Sequence-to-Sequence (seq2seq) Recurrent Neural Networks (RNNs), Long short-term memory (LSTM), etc., as well transformer-based models such as the Generative Pre-trained Transformer-3 (GPT3), Generative Pre-trained Transformer-4 (GPT4), Generative Pre-trained Transformer-J (GPT-J), Text-to-Text Transfer Transformer (T5), Bidirectional and Auto-Regressive Transformers (BART) architectures, and others.

At S450, a call brief is generated based on the rephrased highlight. A call brief may have a predetermined length. For example, the call brief may be limited to a predefined number of sentences or bullet points. The call brief is generated in response to a prompt to the STLM. The prompt includes all highlights and a command to summarize all highlights into a single, short (e.g., up to five sentences), coherent, and informative call brief.

At S460, the call briefs are caused to be displayed to the user, for example, over the user device 140 or stored in a database. In an embodiment, the generated call briefs may be utilized to train the highlight classifiers.

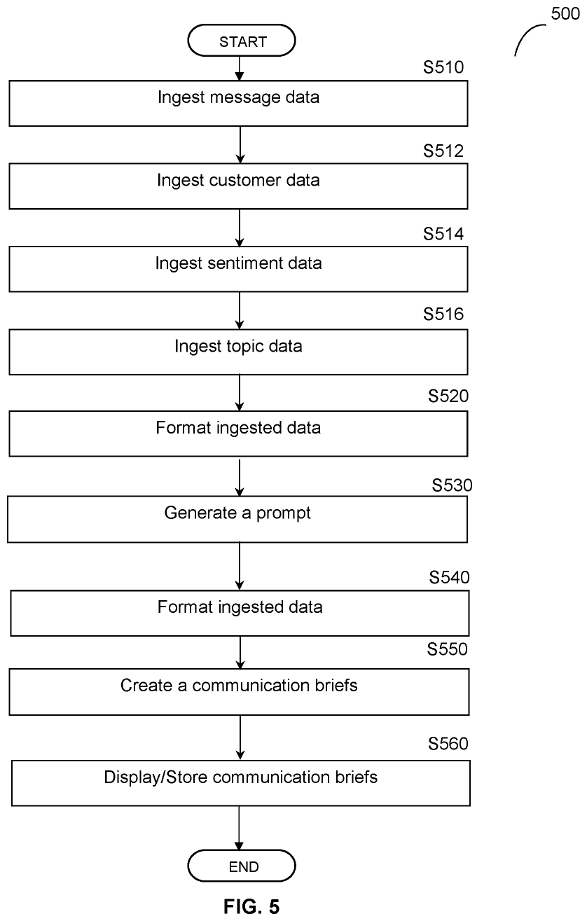

FIG. 5 is an example flowchart 500 illustrating a method for generating communication summaries according to an embodiment.

In an embodiment, the method is performed by the summary generator 130, FIG. 1. In this embodiment, the communication summaries are generated from message data derived from correspondences between sales professionals and prospects (customers and potential customers).

At S510, message data is ingested. The message data may be ingested, for example, from one or more data sources (e.g., one or more of the databases 120, FIG. 1) storing data related to communications. Such communications may include, for example, but are not limited to, electronic mails (emails), instant messages (e.g., messages from chat-based tools including Slack, WhatsApp, Teams, etc.), combinations thereof, and the like. In an example implementation, the message data may be messages between sales professionals and customers or potential customers. As noted above, the vast amount of message data that may be ingested in a larger sale process presents challenges in processing efficiently.

At S512, customer data is ingested. The customer data may be ingested, for example, from one or more CRM systems (e.g., CRM system 150), storing data related to deals offered to customers or potential customers, a stage of such deals, and the information on the customers or potential customers.

At S514, sentiment data is ingested. Sentiment data may be ingested, for example, from sentiments of calls between customers or potential customers. The sentiment may be positive, negative, or neutral. In an embodiment, S510, S512, and S514 can be performed in parallel or in a different order.

At S516, the topic data is ingested. The topic data may be ingested, for example, from a topic database holding topics derived for a call based on its transcripts. A topic is the context of the subject matter in the text (i.e., call transcripts). Examples of topics include the subject matter of, for example, but not limited to, “small talk,” “pricing,” “next step,” “contract,” “sports,” and so on. For each call, there may be one or more different topics.

At S520, one or more formatting processes are applied to the ingested message data, and input data (which includes customer data, sentiment data, and topic data) to create a set of unified data formats. Such formats improve the efficiency of the processing by the STLM.

In an embodiment, S520 includes generating data chunks. In an embodiment, the data chunks are generated by splitting the message data into a fixed-size of data chunks, splitting the sentiment data into a fixed-size of data chunks, and extracting customer data from the CRM system into a predefined data format.

In an embodiment, S520 may include filtering out data chunks that cannot add meaningful information to the summary generation. For example, such data chunks that may be filtered out may be emails exchanged that are neither related to a deal being offered nor related to a meeting schedule. Any data chunks related to exchanged messages characterized as “small talk” may also be excluded.

At S530, a prompt for the STLM is created based on the formatted input data. A prompt typically includes a command, background details, and a text that the command operates on. For example, a prompt command may include “Rephase”, “Format”, “Reword”, and the like. A prompt may include more than one command. The background details may be based on (formatted) data related to customer data and sentiment data. The text that the command operates on includes a message data chunk from the message data. A prompt may be generated for each message data chunk created from the message data.

At S540, each created prompt is fed to the STLM, which outputs a summary. That is, as a prompt is generated for each message data chunk, the STLM outputs a summary per chunk. In an example embodiment, the output summary may be in the format of bullet points in a third-person language. However, it should be noted that the summaries can be generated in other formats or forms.

At S550, a communication brief is generated by canonizing the summaries output by the STLM. A brief is a canonical representation of the summary and includes a simplified transcript and/or a communication brief.

At S560, the communication brief is displayed to the user (e.g., a sales professional), for example, over the user device 140 and/or stored in a database. In an embodiment, the generated communication briefs may be utilized to train the STLM.

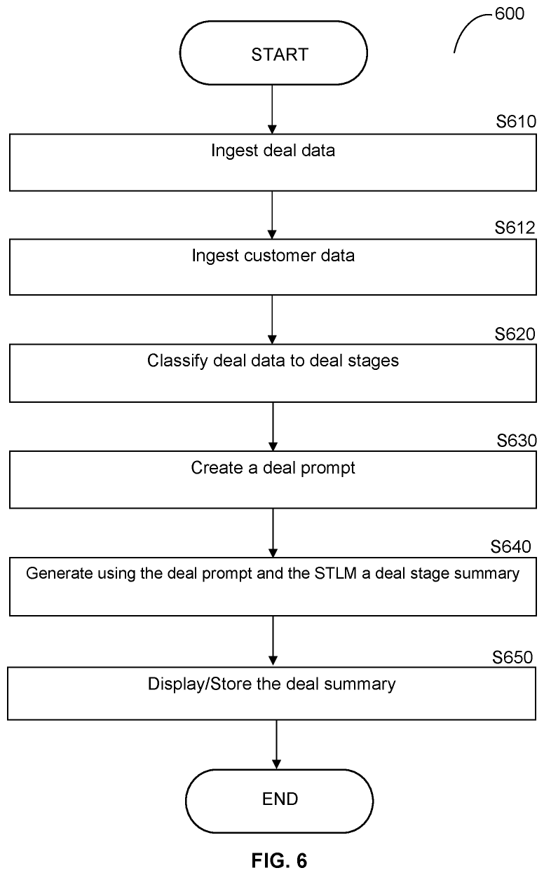

FIG. 6 is an example flowchart 600 illustrating a method for generating deal summaries according to an embodiment. In an embodiment, the method is performed by the generator 130, FIG. 1. In this embodiment, the deal summaries are generated from message data derived from correspondences between a user and a prospect.

At S610, deal data is ingested. The deal data may be ingested from at least call briefs and communication summaries that have been generated, as discussed above. The deal data is stored in one or more databases (e.g., a database 120).

At S612, customer data is ingested. The customer data may be ingested, for example, from one or more CRM systems storing data related to deals offered to customers or potential customers, a stage of such deals, and the information on the customers or potential customers. In an embodiment, S610 and S612 can be performed in parallel or in a different order. Deal summary data includes deal data, customer data, and message data.

At S620, a classification process is applied to the ingested deal data to classify such data based on the deal stage. The classification may be based on customer data retrieved from a CRM system. The deal stage may include pre-sale, offer sent, deal closed, etc. In an embodiment, S620 may be optional.

At S630, a deal prompt for the STLM is created based on the ingested deal data. In an embodiment, a deal prompt is generated for each deal stage. As noted above, a prompt typically includes a command, background details, and text that the command operates on.

At S640, each created deal prompt is fed to the STLM, which outputs a summary of the deal stage. In an embodiment, such a deal summary includes the stage of the deal, what has been achieved in the deal so far, what the next steps are to close the deal, what the concerns are in closing the deal, and so on.

At S650, the deal stage summary is displayed to the user (e.g., sales professional), for example, over the user device 140, and/or stored in a database. In an embodiment, the generated deal stage summary may be utilized to train the STLM.

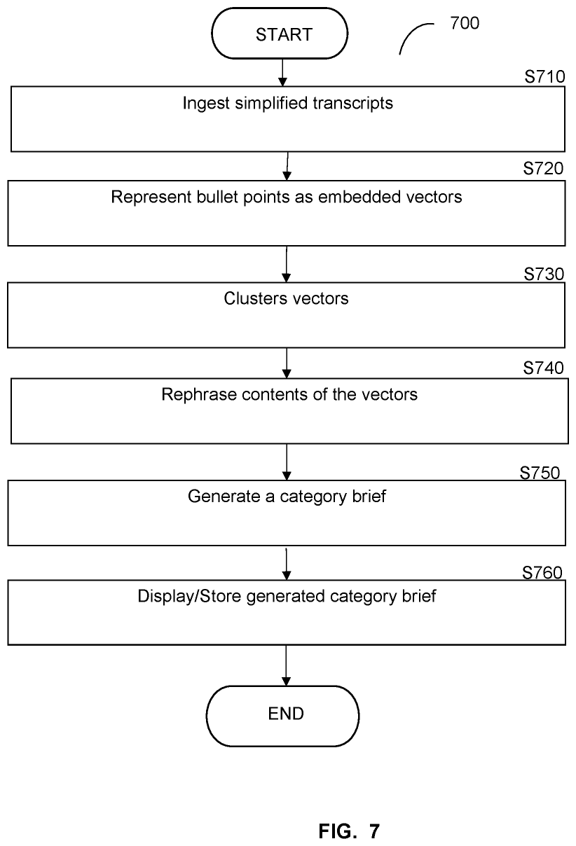

FIG. 7 shows an example flowchart 700 illustrating a method for generating conversation categories according to an embodiment. In an embodiment, the method is performed by the summary generator 130, FIG. 1. In this embodiment, the conversation highlights summaries are based on simplified transcripts.

At S710, a simplified transcript is ingested. The process for generating the simplified transcript is discussed in greater detail above. In an embodiment, a simplified transcript includes a list of bullet points.

At 720, each bullet point is represented as an embedded vector using an embedding technique. The embedding technique may include sentence or word embedding techniques, discussed in the related art, examples of which are provided above.

At S730, bullet points (in their embedded form) are clustered to provide clusters of bullet points with similar meanings. Bullet points may be grouped together. For example, bullet points may be clustered and/or classified. Each cluster may include bullet points representing a semantic similarity. That is, the bullet points are clustered based on the semantic similarities. In an embodiment, S730 includes clustering the bullet points' embedding values of the respective bullet points in the simplified transcript. The clustering is performed such that small, compact clusters are formed. Since close vectors have similar semantic meanings, bullet points in a cluster is expected to demonstrate a similar meaning.

At S740, the clusters are fed into a rephrasing language model trained to rephrase each cluster into a concise, fluent, and self-contained sentence(s), which includes the important information from the bullet points regarding each of the identified clusters (or highlights). In an embodiment, the prompt to the rephrasing language model may include the simplified transcripts and each cluster. The rephrasing language model may be trained on rephrasing algorithms, including, for example, but not limited to, Sequence-to-Sequence (seq2seq) Recurrent Neural Networks (RNNs), Long short-term memory (LSTM), etc., as well transformer-based models such as the Generative Pre-trained Transformer-3 (GPT3), Generative Pre-trained Transformer-4 (GPT4), Generative Pre-trained Transformer-J (GPT-J), Text-to-Text Transfer Transformer (T5), Bidirectional and Auto-Regressive Transformers (BART) architectures, and others.

At S750, a category brief is generated based on the rephrased contents of each cluster (i.e., rephrased bullet points). A category brief may have a predetermined length. For example, the category brief may be limited to a predefined number of sentences or bullet points. For example, the category brief may be limited to a predefined number of five bullet points. Further, a category brief may include a title, a short description of the category, and rephrased bullet points. In an example embodiment, the category brief may be a report for each of the generated clusters that represent similar content or meaning.

At S760, the category briefs are displayed to the user, for example, over the user device 140 or stored in a database. In an embodiment, the generated category briefs may be utilized to train the highlight classifiers.

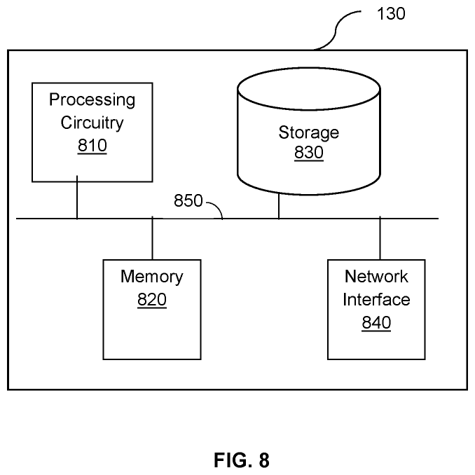

FIG. 8 is an example schematic diagram of a summary generator 130 according to an embodiment. The summary generator 130 includes a processing circuitry 810 coupled to a memory 820, a storage 830, and a network interface 840. In an embodiment, the components of the generator 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read-only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 840 allows the generator 130 to communicate with, for example, the databases 120, the user device 140, and the like.

It should be understood that the embodiments described herein are not limited to the specific architecture illustrated in FIG. 8, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for efficiently generating a brief of a call summary, the method comprising:
ingesting at least one simplified transcript, wherein a simplified transcript is a summarization of a transcript of a call and includes a plurality of bullet points of at least one main subject;
representing each bullet point of the plurality of bullet points of the simplified transcript as an embedded vector using an embedding technique;
determining at least one grouping of the plurality of bullet points based on the embedded vector, wherein the at least one grouping includes at least one bullet point;
feeding the at least one grouping into a trained rephrasing model to generate a rephrased content for each of the at least one grouping; and
generating a summarized brief based on the rephrased content of the at least one grouping, wherein the summarized brief is generated as natural language textual data below a predetermined length.

2. The method of claim 1, further comprising:
causing a display of the generated summarized brief via a user device.

3. The method of claim 1, further comprising:
classifying a bullet point of the plurality of bullet points into a predefined conversation highlight using a trained machine learning model, wherein the at least one grouping of the at least one of the plurality of the bullet points is classified as a same conversation highlight.

4. The method of claim 3, wherein the conversation highlight is any one of: an action item, a customer pain point, a customer request, and a customer question.

5. The method of claim 1, wherein the at least one grouping includes a subset of the plurality of bullet points that are clustered based on respective embedded vectors.

6. The method of claim 1, further comprising,
ingesting deal summary data from the summarized brief;
classifying the ingested deal summary data based on a deal stage;
generating a deal prompt for each deal stage, wherein the deal prompt is generated based on the deal summary data;
feeding the generated deal prompt to a trained language model to generate a deal summary, wherein the deal summary is a comprehensive summarization of a deal; and
causing a display of the deal summary.

7. The method of claim 6, wherein the deal summary data includes at least one of: deal data, customer data, and message data.

8. The method of claim 6, wherein the trained language model is a specific-trained language model that is specific to a customer.

9. The method of claim 6, wherein the call summary of the summarized brief is a sales call summary, and the trained language model is trained on customer's sales data.

10. A non-transitory computer readable medium having stored thereon instructions for causing a processing circuitry to execute a process, the process comprising:
ingesting at least one simplified transcript, wherein a simplified transcript is a summarization of a transcript of a call and includes a plurality of bullet points of at least one main subject;
representing each bullet point of the plurality of bullet points of the simplified transcript as an embedded vector using an embedding technique;
determining at least one grouping of the plurality of bullet points based on the embedded vector, wherein the at least one grouping includes at least one bullet point;
feeding the at least one grouping into a trained rephrasing model to generate a rephrased content for each of the at least one grouping; and
generating a summarized brief based on the rephrased content of the at least one grouping, wherein the summarized brief is generated as natural language textual data below a predetermined length.

11. A system for efficiently generating a brief of a call summary, the system comprising:
a processing circuitry; and
a memory, the memory containing instructions that, when executed by the processing circuitry, configure the system to:
ingest at least one simplified transcript, wherein a simplified transcript is a summarization of a transcript of a call and includes a plurality of bullet points of at least one main subject;
represent each bullet point of the plurality of bullet points of the simplified transcript as an embedded vector using an embedding technique;
determine at least one grouping of the plurality of bullet points based on the embedded vector, wherein the at least one grouping includes at least one bullet point;
feed the at least one grouping into a trained rephrasing model to generate a rephrased content for each of the at least one grouping; and
generate a summarized brief based on the rephrased content of the at least one grouping, wherein the summarized brief is generated as natural language textual data below a predetermined length.

12. The system of claim 11, wherein the system is further configured to:
cause a display of the generated summarized brief via a user device.

13. The system of claim 11, wherein the system is further configured to:
classify a bullet point of the plurality of bullet points into a predefined conversation highlight using a trained machine learning model, wherein the at least one grouping of the at least one of the plurality of the bullet points is classified as a same conversation highlight.

14. The system of claim 13, wherein the conversation highlight is any one of: an action item, a customer pain point, a customer request, and a customer question.

15. The system of claim 11, wherein the at least one grouping includes a subset of the plurality of bullet points that are clustered based on respective embedded vectors.

16. The system of claim 11, wherein the system is further configured to:
ingest deal summary data from the summarized brief;
classify the ingested deal summary data based on a deal stage;
generate a deal prompt for each deal stage, wherein the deal prompt is generated based on the deal summary data;
feed the generated deal prompt to a trained language model to generate a deal summary, wherein the deal summary is a comprehensive summarization of a deal; and
cause a display of the deal summary.

17. The system of claim 16, wherein the deal summary data includes at least one of: deal data, customer data, and message data.

18. The system of claim 16, wherein the trained language model is a specific-trained language model that is specific to a customer.

19. The system of claim 16, wherein the call summary of the summarized brief is a sales call summary, and the trained language model is trained on customer's sales data.
